(19) United States
(12) Patent Application Publication
(10) Pub. No.: US 2016/0186939 A1
(43) Pub. Date: Jun. 30, 2016

(54) LIGHT-THERMAL SEPARATING LIQUID MOTION LAMP

(71) Applicant: SU-FANG HO, NEW TAIPEI CITY (TW)

(72) Inventor: SU-FANG HO, NEW TAIPEI CITY (TW)

(21) Appl. No.: 14/597,426

(22) Filed: Jan. 15, 2015

(30) Foreign Application Priority Data
Dec. 29, 2014 (TW) 103223171

(51) Int. Cl. F21K 99/00; F21V 17/12; F21V 23/02; F21V 17/10; F21V 33/00; F21V 23/00

(52) U.S. Cl. CPC F21K 9/58; F21V 33/0028; F21V 23/001; F21V 23/004; F21V 23/026; F21V 17/104; F21V 17/12; F21W 2121/00

(57) ABSTRACT

A light-thermal separating liquid motion lamp comprises a frame body, a mounting seat, a liquid motion lamp, and a light-thermal separating circuit module in which the frame body has a placing space at the bottom having the mounting seat being disposed therein, and the liquid motion lamp is disposed on the mounting seat; the light-thermal circuit module has a LED bulb and at least one resistor on a circuit board thereon, and the circuit board is disposed below the liquid motion lamp within an appropriate distance; whereby the resistor would produce heat to cause the flowing of the liquid inside the liquid motion lamp, and the LED bulb can projects lights on the liquid motion lamp as well, creating a magnificent and vivid visual effect together with the flowing glitters therein.

### BACKGROUND OF THE INVENTION

1. Field of the Invention

The present invention relates to a liquid motion lamp, particularly to one that has a function of light-thermal separation and can be applied to desk lamps and pedant lamps.

2. Description of the Related Art

Liquid motion lamps including lava lamps can cause the flowing of a first liquid substance inside by the heat produced by bulbs thereof; a second substance in the first liquid substance is therefore flowing as well. Besides, the random flowing and the lights projected from the bulbs create a splendid and magnificent visual effect. A liquid motion lamp has at least one bulb to provide the heat energy for the liquid and substances inside to flow around. However, the temperature of the bulb would rise increasingly with long-term usage. This may cause serious damages and harm to the users, and there is a problem of expenditure of bulbs as well,

Liquid motion lamps have been a favorite choice for decorative fittings, but the only function of decoration has become inadequate lately. Consequently, operators started to put light bulbs on the lamps to expand a lighting function, and such application has grown favorable among the consumers. Nevertheless, there comes a bottleneck in the development—the expenditure of bulbs; such obstacle undoubtedly calls for improvements to go further in the industry.

### SUMMARY OF THE INVENTION

A primary object of the present invention is to provide a liquid motion lamp that has a light-thermal separating circuit board with LED bulbs and resistors to cause the flowing of the liquid motion lamp and consequently create a magnificent visual effect. Meanwhile, the LED bulbs would obtain longer durability since the circuit board is maintained at a low temperature.

Another object of the present invention is to provide a light-thermal separating liquid motion lamp that can be applied to desk lamps.

Yet another object of the present invention is to provide a light-thermal separating liquid motion lamp that can be applied to pendant lights and further to droplights.

To achieve the objects mentioned above, the present invention comprises a frame body including a placing space and having at least partial thereof as hollow section for a wire to be disposed through; a mounting seat disposed at the bottom of the placing space with a plurality of heat dissipating holes on the periphery thereof; a liquid motion lamp formed by a transparent bottle with liquid and a plurality of glitters therein and disposed on the mounting seat in the placing space; a light-thermal separating circuit module having a circuit board on which a LED bulb and at least one resistor are disposed, under which a conducting wire is connected; the other end of the conducting wire being connected to a power supply cord linked to an external transformer; and the circuit board being disposed inside the mounting seat and below the liquid motion lamp in an appropriate distance; whereby the heat energy produced by the resistor when the power supply cord is electrified and the electrical current is passing through is able to cause the flowing of the liquid inside the liquid motion lamp; moreover, lights are produced when the electrical current is passing through the LED bulb, and they can project on the plurality of glitters flowing with the liquid inside the liquid motion lamp, displaying a magnificent and vivid visual effect.

The present invention further has the lower section of the frame body fixed on a base, a light bulb and lamp holder disposed on the top thereof with a lampshade covering the light bulb, and a lighting wire having an end thereof connect to the lamp holder and the other end thereof joined the conducting wire of the light-thermal separating circuit module to connect to the power supply cord linked to an external transformer, so as to form a lighting device with a liquid motion lamp. The base is in n-shape, and has an assembling hole on the top surface thereof and a hollow bolt with the upper of which disposed at the bottom of the light-thermal separating circuit module and the lower of which disposed through the bottom of the frame body and the assembling hole of the base. Then the light-thermal separating circuit module, the frame body and the base are fixed tightly in position by a wing nut.

The present invention further includes a long rod which is hollow and connecting the top of the frame body with the bottom of a canopy and a transmission wire having an end thereof connecting with the conducting wire of the light-thermal separating circuit module a transmission wire and the other end thereof passing through the hollow section and the long rod, then connecting to a power supply cord linked to an external transformer outside the canopy, so as to form a pendant light with a liquid motion lamp. The mounting seat further includes a lower part and an upper part, of which the lower part is in u-shape and disposed at the bottom of the placing space and the upper part is hollow and has a plurality of bumps arranged on the upper section of the inner side and a plurality of heat dissipating holes around the outside periphery; the upper part is mounted on the inner edge of the lower part. Additionally, the present invention may further includes a plurality of hollow long rods in different length, each linking to a corresponding frame body of the present invention at the top thereof and the other end of the long rods being hung separately under a canopy and a plurality of transmission wires each having an end thereof connecting with a corresponding conducting wire and the other end connecting with a power supply cord linked to an external transformer outside the canopy, so as to form a set of droplights with liquid motion lamps.

As structures disclosed above, the present invention has a magnificent and vivid visual effect with a light-thermal separating function by combining the LED bulb and the resistors. Also, the LED bulb has a longer durability since the circuit board thereof is maintained at a low temperature. Meanwhile, the present invention is able to be applied to desk lamps, pendant lights and droplights, obtaining itself more credits and advantages in practicability.

### BRIEF DESCRIPTION OF THE DRAWINGS

FIG. 1 is an exploded view of the present invention in a preferred embodiment;

FIG. 2 is a sectional view of the present invention in a preferred embodiment; FIG. 3A is a perspective view of the present invention in a preferred embodiment;

FIG. 3B is a assembled sectional view of the present invention in a preferred embodiment;

FIG. 4 is a perspective view of the present invention applied to desk lamps; FIG. 5 is a sectional view of FIG. 4;

FIG. 6 is another perspective view of the present invention applied to desk lamps with a lampshade thereon;

FIG. 7 is a perspective view of the present invention applied to pedant lights;

FIG. 8 is a sectional view of FIG. 7; and

FIG. 9 is a perspective view of the present invention applied to droplights, viewing from the front.

### DETAILED DESCRIPTION OF THE PREFERRED EMBODIMENT

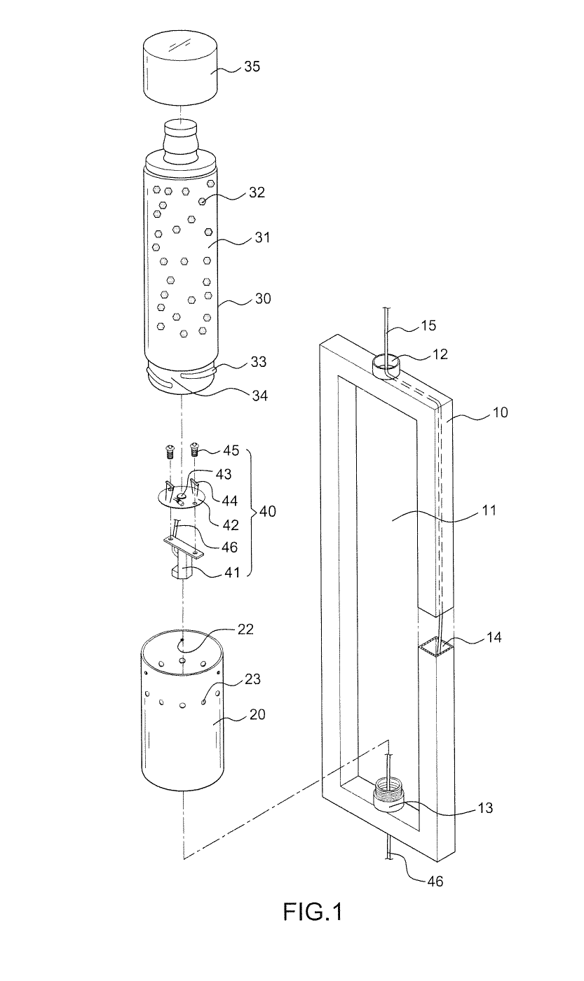

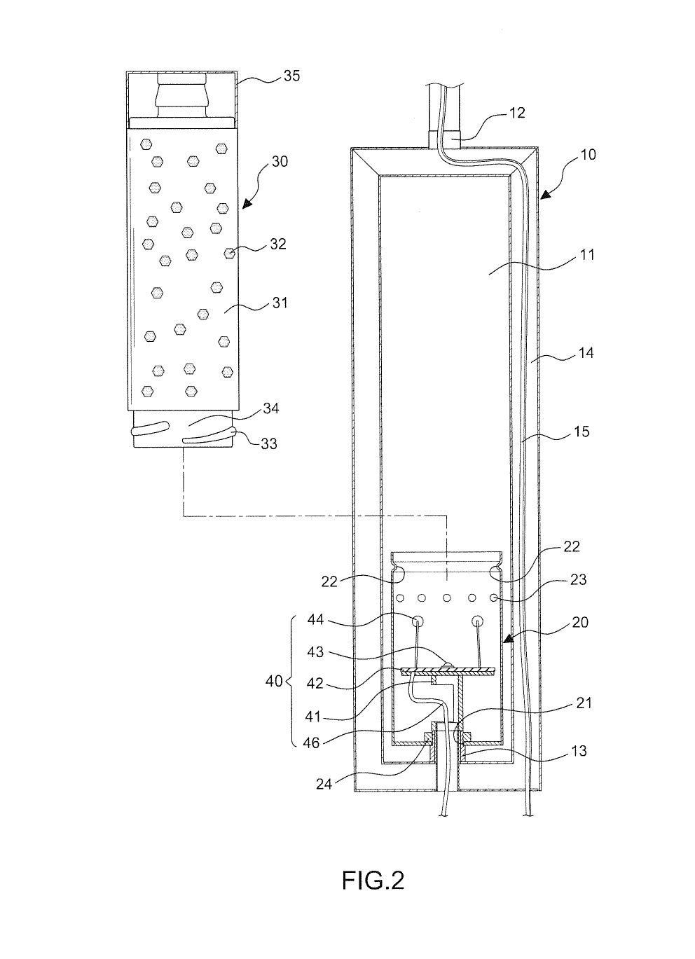

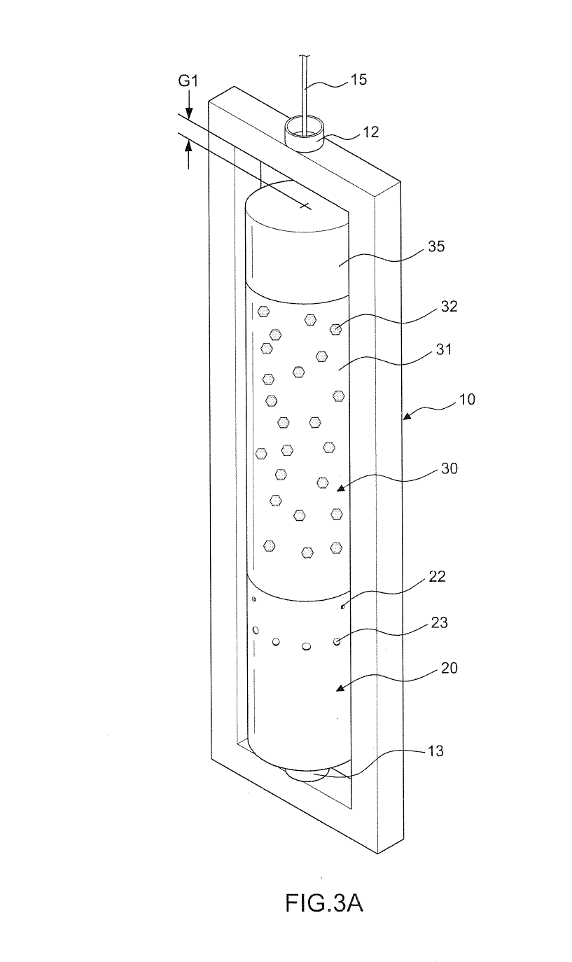

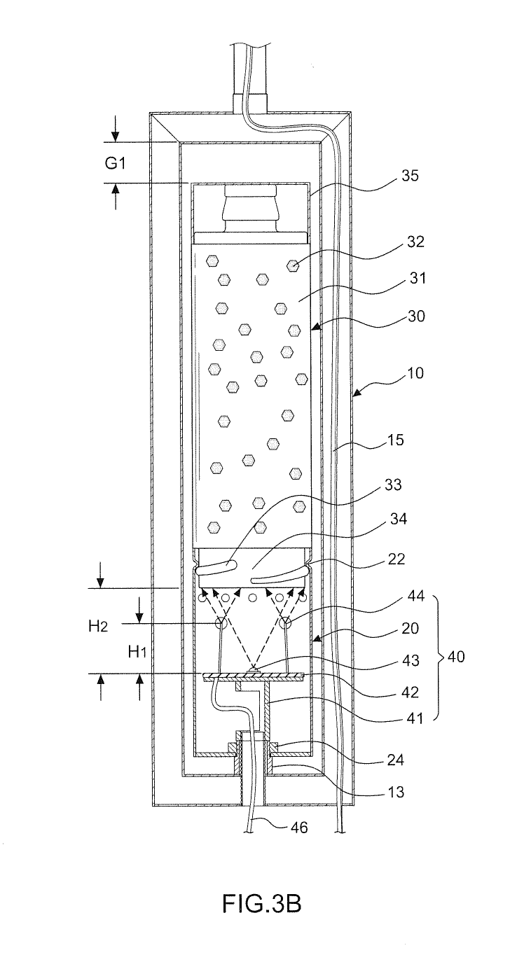

Referring to FIGS. 1-3A and 3B, the structure of the present invention comprises a frame body 10, a mounting seat 20. a liquid motion lamp 30 and a light-thermal separating circuit module 40.

The frame body 10 includes a placing space 11, an upper hole 12 and a lower hole 13. It has at least partial thereof as hollow section 14 that is interlinked with the upper hole 12 and the lower hole 13 for a wire 15 to be disposed through. The mounting seat 20 is in U-shape and disposed at the bottom of the placing space 11, with a positioning hole 21 arranged at the bottom and the upper section thereof having a plurality of bumps 22 on the inner side and a plurality of heat dissipating holes 23 on the outside periphery. The positioning hole 21 is mounted on the outside periphery of the lower hole 13 and fixed in position by a nut 24. The liquid motion lamp 30 is formed by a transparent bottle with liquid 31 and a plurality of glitters 32 therein. The lower section thereof has a plurality of protrusions 33 forming a spiral engaging area 34 for the bumps 22 on the inner side of the mounting seat 20 to be engaged spirally and therefore fix the liquid motion lamp 30 on the mounting seat 20 in the placing space 11. The upper section of the liquid motion lamp 30 further has a decorative iron cover 35 arranged thereon, and an appropriate clearance G1 is arranged in-between for easy assembling.

The light-thermal separating circuit module 40 has a fixing element 41 disposed above the lower hole 13, and a circuit board 42 on which a LED bulb 43 and two resistors 44 are disposed; the resistors 44 are arranged at an appropriate height H1 above the surface of the circuit board 42 in order to prevent the circuit board 42 and the LED bulb 43 from being damaged due to the heat, and the circuit board 42 is disposed below the liquid motion lamp 30 within an appropriate distance 112 so that the resistors 44 and the LED bulb 43 could provide enough heat and light energy for the liquid motion lamp 30. The circuit board 42 is fixed on the fixing element 41 by two screws 45 under which a conducting wire 46 is connected; the other end of the conducting wire 46 is connected to a power supply cord (not shown) linked to an external transformer (not shown);

whereby the heat energy produced by the resistors 44 when the power supply cord 16 is electrified and the electrical current is passing through is able to cause the flowing of the liquid 31 inside the liquid motion lamp 30; moreover, lights are produced when the electrical current is passing through the LED bulb 43, and they can project on the plurality of glitters 32 flowing with the liquid 31 inside the liquid motion lamp 30, displaying a magnificent and vivid visual effect.

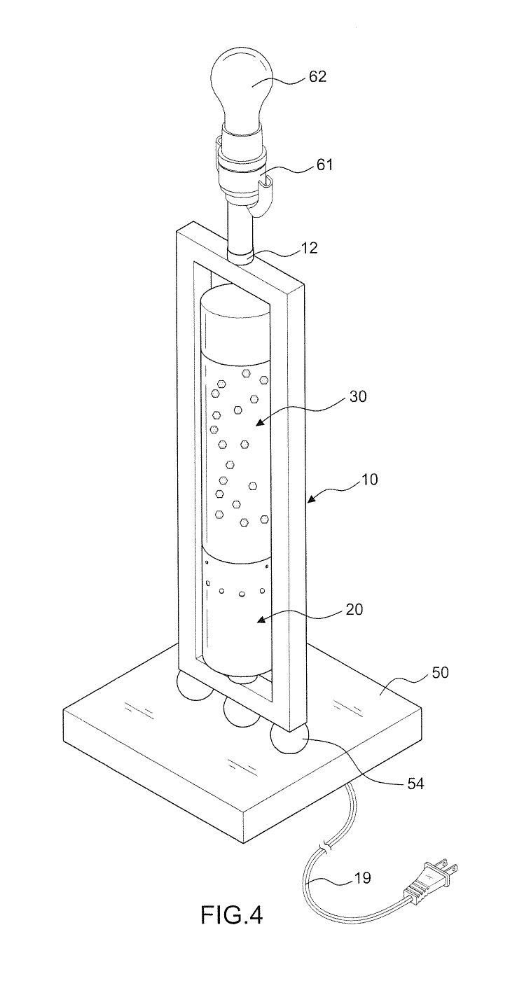

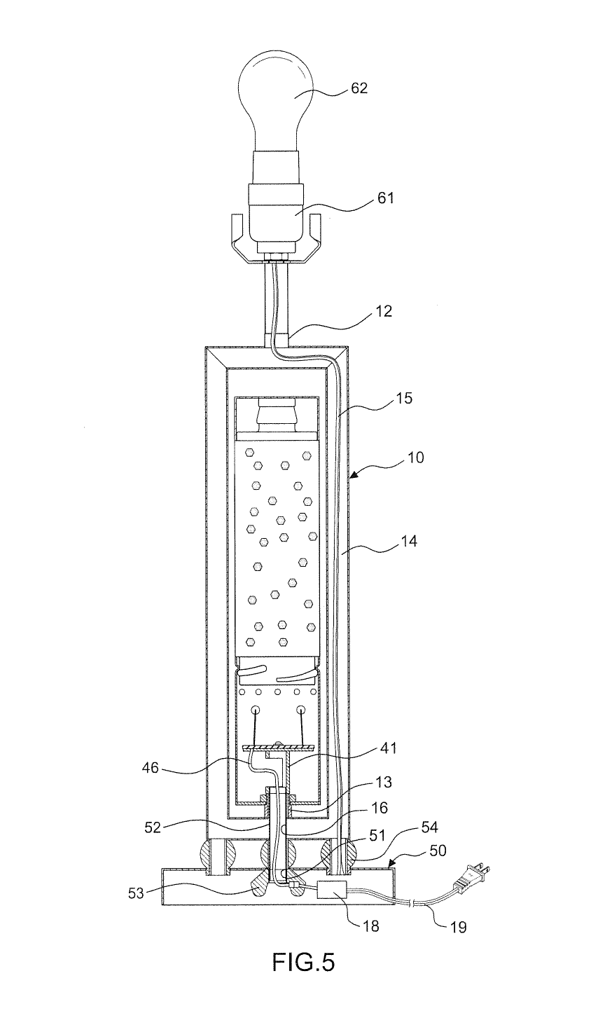

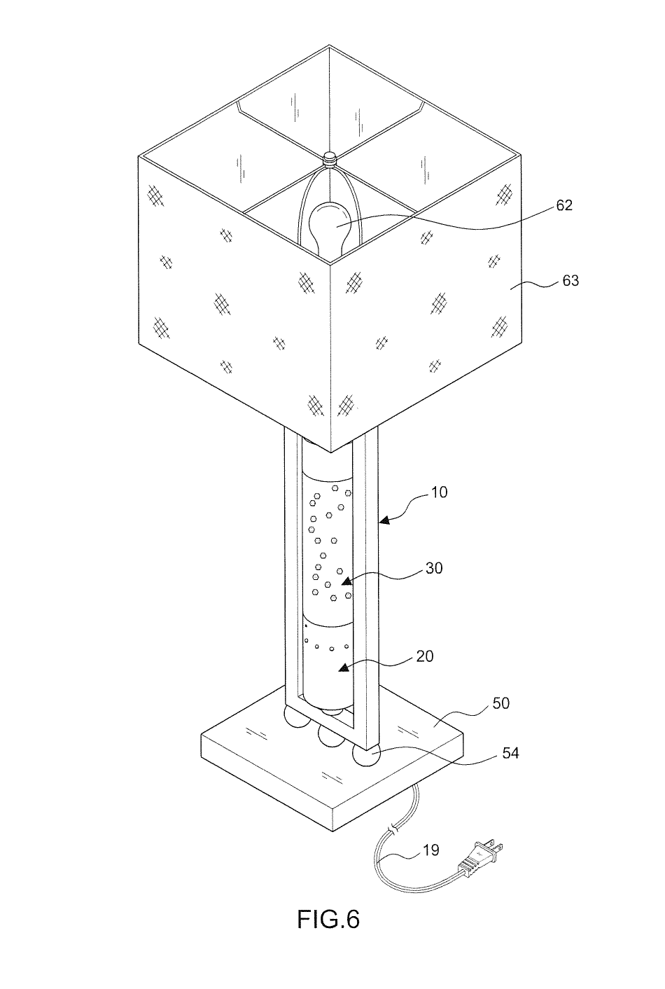

Referring to FIGS. 4-6, in an embodiment of the present invention applied to desk lamps, the present invention has the lower section of the frame body 10 fixed on a base 50 and a lamp holder 60 disposed on the upper hole 12; a light bulb 62 is disposed on the lamp holder 60 and a lighting wire 15 has an end thereof disposed through the hollow section 14 to connect to the lamp holder 60 and the other end thereof joined the conducting wire 46 of the light-thermal separating circuit module 40 to connect to the power supply cord 19 linked to an external transformer 18, forming a lighting device with a liquid motion lamp.

The base 50 is in n-shape, having an assembling hole 51 on the top surface thereof, a through hole 16 arranged below the lower hole 13 of the frame body 10 and having the same axis as the lower hole 13, and a hollow bolt 52 with the upper section thereof disposed at the bottom of the fixing element 41 of the light-thermal separating circuit module 40 and the lower section thereof disposed through the lower hole 13 of the frame body 10, the through hole 16 and the assembling hole 51 of the base 50; then the light-thermal separating circuit module 40, the frame body 10 and the base 50 are fixed tightly in position by a wing nut 53. In this embodiment, the present invention further includes three ball seats 54 between the frame body 10 and the base 50, and a lampshade 63 disposed above the lamp holder 61, increasing artistic and practical features to the desk lamp combined with the present invention.

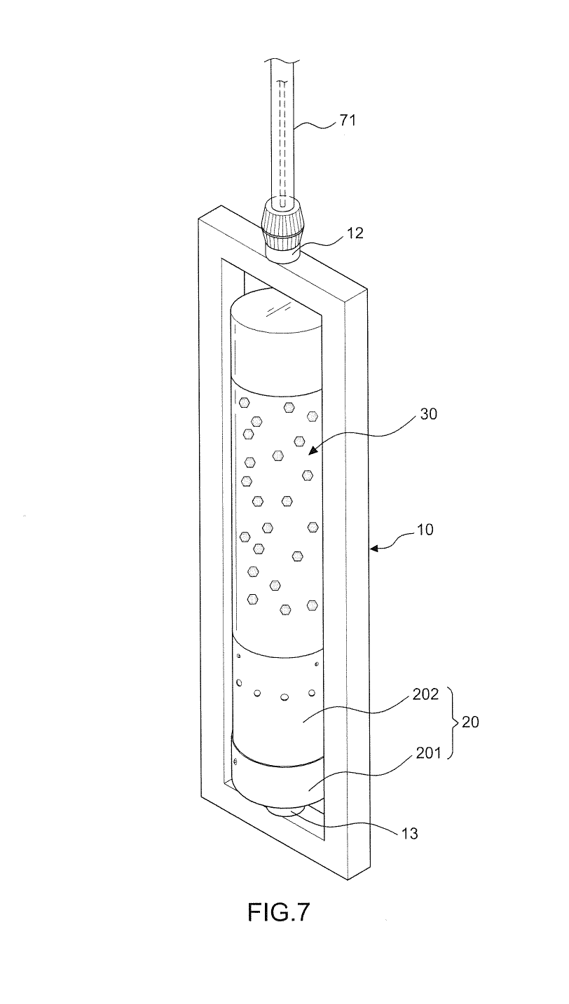

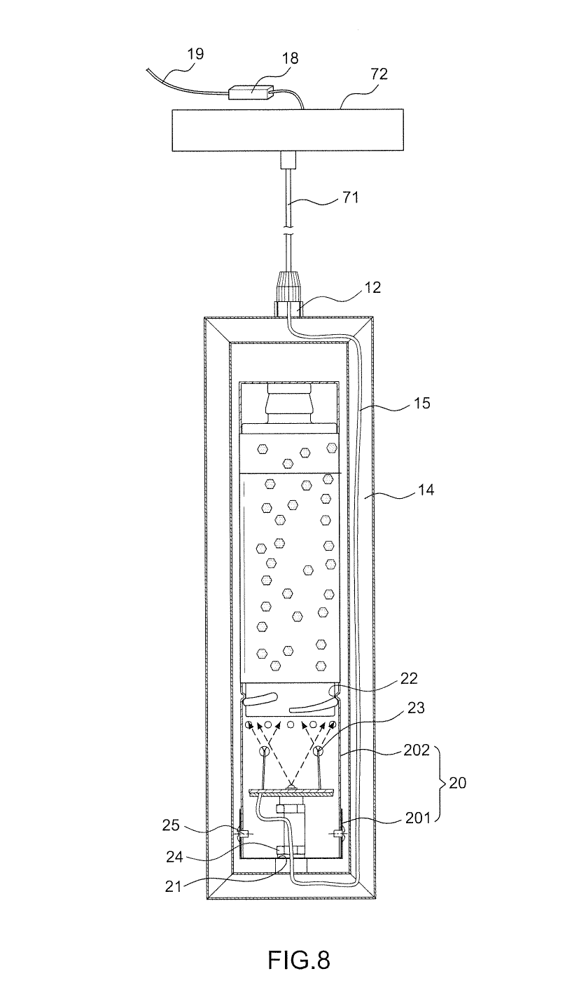

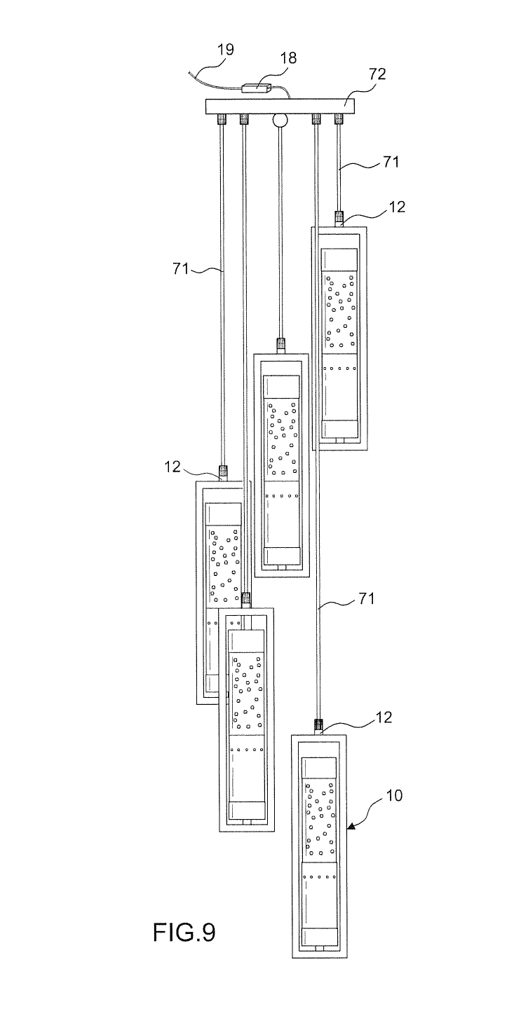

With reference to FIGS. 7-9, in an embodiment of the present invention applied to pendant lights, the present invention further includes a long rod 71 which is hollow and connecting the top of the upper hole 12 with the bottom of a canopy 72; the conducting wire 46 of the light-thermal separating circuit module 40 is connecting with a transmission wire 15 that has the other end thereof passing through the hollow section 14 and the long rod 71, and connecting to a power supply cord 19 linked to an external transformer 18 outside the canopy 72, so as to form a pendant light with a liquid motion lamp.

The mounting seat 20 further includes a lower part 201 and an upper part 202; the lower part 201 thereof is in u-shape and has a positioning hole 21 at the bottom, mounted on the outside periphery of the lower hole 13 and fixed by a nut 24. The upper part 202 is hollow and has a plurality of bumps 22 arranged on the upper section of the inner side and a plurality of heat dissipating holes 23 around the outside periphery; the upper part 202 is mounted on the inner edge of the lower part 201 by a plurality of screws 25. In this embodiment, the present invention further includes a plurality of hollow long rods 71 in different length, each linking to a corresponding upper hole 12 of the frame body 10 thereof at the top, and the other end of the long rods 71 is hung separately under a canopy 72; a plurality of transmission wires 15 are connecting with a power supply cord 19 linked to an external transformer 18 outside the canopy 72 after being cascaded, so as to form a set of droplights with liquid motion lamps.

With structures disclosed above, the present invention has a circuit board 42 separating the light and the heat from the LED bulb 43 and the resistors 44, and is placed below the liquid motion lamp 30 in order to create a magnificent and vivid visual effect. Meanwhile, the LED bulb 43 has longer durability since the circuit board 50 is maintained at a low temperature. In addition, the present invention can be applied to desk lamps by combing with a base 50 and a light bulb 62, forming a desk lamp with a liquid motion lamp; or it can be applied to pendant lights by combing with a long rod 71 and a canopy 72, forming a pendant light with a liquid motion lamp or even further, a set of droplights.

Although a particular embodiment of the invention has been described in detail for purposes of illustration, various modifications and enhancements may be made without departing from the spirit and scope of the invention.

Accordingly, the invention is not to be limited except as by the appended claims.

What is claimed is:

1. A light-thermal separating liquid motion lamp, comprising:
a frame body including a placing space and having at least partial thereof as hollow section for a wire to be disposed through;
a mounting seat disposed at the bottom of the placing space with a plurality of heat dissipating holes on the periphery thereof;
a liquid motion lamp formed by a transparent bottle with liquid and a plurality of glitters therein and disposed on the mounting seat in the placing space;
a light-thermal separating circuit module having a circuit board on which a LED bulb and at least one resistor are disposed, under which a conducting wire is connected; the other end of the conducting wire being connected to a power supply cord linked to an external transformer; and the circuit board being disposed inside the mounting seat and below the liquid motion lamp in an appropriate distance;
whereby the heat energy produced by the resistor when the power supply cord is electrified and the electrical current is passing through is able to cause the flowing of the liquid inside the liquid motion lamp; moreover, lights are produced when the electrical current is passing through the LED bulb, and they can project on the plurality of glitters flowing with the liquid inside the liquid motion lamp, displaying a magnificent and vivid visual effect.

2. The light-thermal separating liquid motion lamp as claimed in claim 1, wherein the resistors are disposed at an appropriate height above the surface of the circuit board, in order to prevent the circuit board and the LED bulb from being damaged due to the heat.

3. The light-thermal separating liquid motion lamp as claimed in claim 1, wherein the upper section of the mounting seat has a plurality of bumps on the inner side, and the lower section of the liquid motion lamp has a plurality of protrusions forming a spiral engaging area for the bumps to be engaged spirally and therefore fix the liquid motion lamp on the mounting seat.

4. The light-thermal separating liquid motion lamp as claimed in claim 3, wherein the upper section of the liquid motion lamp further has a decorative iron cover arranged thereon, and an appropriate clearance is arranged in-between for easy assembling.

5. The light-thermal separating liquid motion lamp as claimed in claim 1, wherein the lower section of the frame body is further fixed on a base, and a lamp holder is further disposed on the top thereof; a light bulb is disposed on the lamp holder, and a lighting wire has an end thereof disposed through the hollow section to connect to the lamp holder and the other end thereof joined the conducting wire of the light-thermal separating circuit module to connect to the power supply cord linked to an external transformer, forming a lighting device with a liquid motion lamp.

6. The light-thermal separating liquid motion lamp as claimed in claim 5, wherein the base is in n-shape, having an assembling hole on the top surface thereof, a hollow bolt with the upper of which disposed at the bottom of the light-thermal separating circuit module and the lower of which disposed through the bottom of the frame body and the assembling hole of the base, then the light-thermal separating circuit module, the frame body and the base are fixed tightly in position by a wing nut.

7. The light-thermal separating liquid motion lamp as claimed in claim 5, wherein the present invention further includes a lampshade disposed above the lamp holder.

8. The light-thermal separating liquid motion lamp as claimed in claim 1, wherein the present invention further includes a long rod which is hollow and connecting the top of the frame body with the bottom of a canopy; the conducting wire of the light-thermal separating circuit module connecting with a transmission wire that has the other end thereof passing through the hollow section and the long rod, and connecting to a power supply cord linked to an external transformer outside the canopy, so as to form a pendant light with a liquid motion lamp.

9. The light-thermal separating liquid motion lamp as claimed in claim 8, wherein the mounting seat further includes a lower part and an upper part, of which the lower part is in u-shape and disposed at the bottom of the placing space and the upper part is hollow and has a plurality of bumps arranged on the upper section of the inner side and a plurality of heat dissipating holes around the outside periphery; the upper part being mounted on the inner edge of the lower part.

10. The light-thermal separating liquid motion lamp as claimed in claim 1, wherein the present invention further includes a plurality of hollow long rods in different length, each linking to a corresponding frame body of the present invention at the top, and the other end of the long rods being hung separately under a canopy; a plurality of transmission wires each having an end thereof connecting with a corresponding conducting wire and the other end connecting with a power supply cord linked to an external transformer outside the canopy, so as to form a set of droplights with liquid motion lamps.
